(19) United States
(12) Patent Application Publication
(10) Pub. No.: US 2023/0236948 A1
(43) Pub. Date: Jul. 27, 2023

(54) Cost-Optimized Recommendations from Inaccurate Event Logs

(71) Applicant: Dell Products L.P., Round Rock, TX (US)

(72) Inventors: Ben Fauber, Austin, TX (US); Lee Saeugling, Austin, TX (US)

(21) Appl. No.: 17/581,224

(22) Filed: Jan. 21, 2022

(51) Int. Cl. G06F 11/34; G06F 16/901

(52) U.S. Cl. CPC G06F 11/3476; G06F 16/9024

(57) ABSTRACT

A system can determine groups of repair actions taken for computers from an event log of repair actions. The system can create a weighted, directed graph from the groups of repair actions, wherein respective vertices of the weighted, directed graph correspond to respective repair states, and wherein respective edges of the weighted, directed graph between two vertices of the weighted, directed graph represent respective costs of taking respective actions. The system can determine a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. The system can store an identification of a first group of vertices of the path.

### BACKGROUND

Computers can become malfunctioning, and then be repaired. Expert guidance systems can be implemented to aid a technician in diagnosing and repairing a computer.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine groups of repair actions taken for computers from an event log of repair actions. The system can create a weighted, directed graph from the groups of repair actions, wherein respective vertices of the weighted, directed graph correspond to respective repair states, and wherein respective edges of the weighted, directed graph between two vertices of the weighted, directed graph represent respective costs of taking respective actions. The system can determine a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. The system can store an identification of a first group of vertices of the path.

A method can comprise creating, by a system comprising a processor, a weighted, directed graph from groups of repair actions taken for computers in an event log of repair actions, wherein respective vertices of the weighted, directed graph correspond to respective repair states, and wherein respective edges of the weighted, directed graph between two vertices of the weighted, directed graph represent respective costs of taking respective actions. The method can further comprise determining, by the system, a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. The method can further comprise storing, by the system, an identification of a first group of vertices of the path.

An example non-transitory computer-readable medium can comprise instructions that, in response to execution, cause a system comprising a processor to perform operations. These operations can comprise creating a graph from groups of repair actions taken for computers in an event log of repair actions, wherein respective vertices of the graph correspond to respective repair states, and wherein respective edges of the graph between two vertices of the graph represent respective costs of taking respective actions. These operations can comprise determining a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. These operations can comprise storing an identification of a first group of vertices of the path.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate cost-optimized recommendations from inaccurate event logs, in accordance with an embodiment of this disclosure;

FIG. 2 illustrates an example graph with a minimum cost path, and that can facilitate cost-optimized recommendations from inaccurate event logs, in accordance with an embodiment of this disclosure;

FIG. 3 illustrates an example graph with multiple starting vertices, and that can facilitate cost-optimized recommendations from inaccurate event logs, in accordance with an embodiment of this disclosure;

FIG. 4 illustrates an example graph that is optimized, and that can facilitate cost-optimized recommendations from inaccurate event logs, in accordance with an embodiment of this disclosure;

FIG. 5 illustrates an example process flow that can facilitate cost-optimized recommendations from inaccurate event logs, in accordance with an embodiment of this disclosure;

FIG. 6 illustrates another example process flow that can facilitate cost-optimized recommendations from inaccurate event logs, in accordance with an embodiment of this disclosure;

FIG. 7 illustrates another example process flow that can facilitate cost-optimized recommendations from inaccurate event logs, in accordance with an embodiment of this disclosure;

FIG. 8 illustrates an example process flow for optimizing a graph using a cost-minimization function to achieve issue resolution, and that can facilitate cost-optimized recommendations from inaccurate event logs, in accordance with an embodiment of this disclosure;

FIG. 9 illustrates an example process flow for using a Fibonacci heap to facilitate cost-optimized recommendations from inaccurate event logs, in accordance with an embodiment of this disclosure;

FIG. 10 illustrates an example block diagram of a computer operable to execute an embodiment of this disclosure.

### DETAILED DESCRIPTION

### Overview

Actions that repair technicians take to repair a malfunctioning computer can be stored in event logs. The present techniques can be implemented to extract repair events from repair logs, project actions identified in the event logs into a graph network, and optimizing the graph by minimizing a cost function between nodes of the graph. A minimum cost path optimized graph can facilitate process enhancement action recommendations to resolve repair issues. Minimum cost path repair action recommendations can be one or two orders of magnitude less expensive as compared to techniques that implement a trivial shortest path on an unoptimized graph.

Process mining can comprise a combination of data mining and business process management. An objective of process mining can be to derive process insights from event data captured by information systems, where this data can be stored in an event log. Process mining can encompass three main subdomains of study: process discovery, process enhancement, and process conformance checking. These subdomains can all rely on event logs for their information. Event logs often can be an amalgam of data from multiple sources and processes, and can comprise of a table where each row represents a single event with an activity name, case identifier, timestamp, and other associated attributes.

Process-aware information systems can be used to log events associated with the execution of various business processes. A problem with process-aware information systems can arise when there are discrepancies between execution logs and actual execution. When event logs are either partially or fully human-generated (e.g., recorded by a user or technician), there can be an underlying uncertainty related to the accurate logging of the event, timestamp, action, and outcome. If not considered, this uncertainty can lead to inappropriate interpretation of the event logs. For example, in process enhancement, unwittingly mining inaccurate information in an event log can result in recommendations for an incorrect or dangerous action. As such, safeguards can be erected to minimize such unfortunate outcomes by accounting for, or side-stepping, inaccuracies in event logs.

Prior approaches can address inaccurate event logs by considering the probability of certain actions to be true based on their distribution and the observed conditional probabilities between sequences. Additional prior approaches can incorporate clustering-based outlier detection approaches, or irregular data pattern recognition strategies to remedy inaccurate event logs. Furthermore, some prior approaches can involve rearranging event logs into graph network structures to preform graph metric analysis, or graph database queries.

The present techniques can be implemented to apply a minimum cost path approach to remediate inaccurate event logs. The present techniques can differ from prior approaches in viewing the events in an event log as a graph, where a cost and number of steps are minimized to optimize the graph, and thus, optimize the recommended actions. The present techniques can be particularly robust to inaccuracies in event logs when optimization is driven by cost minimization.

A directed simple graph G can be defined as a pair (V, E) where vₙ∈V are the vertices of G, and e∈E are the edges of G that connect the vertices. In some examples, all edges connect distinct vertices, there can be at most one edge between a given pair of vertices, and there are no self-loops. Each e∈E can comprise an unordered pair of vertices, with the edge connecting distinct vertices u and v written as a pair (u, v). Graph G can also be defined by an adjacency matrix A of n×n dimensions containing the elements aij∈A, where aij=1 if vi and vj share an edge, and aij=0 otherwise. That is:

$${a}_{ij} = \{ \begin{matrix}1 & if ( i , j ) ∈ E \\ 0 & otherwise\end{matrix}$$

A path p in G is a sequence of vertices p= [symbol] v₁, v₂, . . . , vₙ [symbol] ∈|V|×|V|× . . . ×|V| such that vᵢ is adjacent to vᵢ₊₁ for 1≤i<n. In this example, p is of length n−1 from v₁ to vₙ, where vᵢ relates to their position in the path sequence and does not to relate to any canonical labeling of the vertices. A graph can have more than one path between v₁ and vₙ.

When each edge in G has unit weight or w(⋅): E→{1}, this can be equivalent to finding the path with the fewest edges. When G has weighted edges, the weight w(u, v) of the edge (u, v)∈E can be stored as a list element in an adjacency list tuple (such as, e=(u, v, w)), or it can be stored in A where aᵢⱼ=wᵤᵥ. A weight of path p= [symbol] v₀, v₁, . . . , vₖ [symbol] can be a sum of the weights of its constituent edges:

$$w ( p ) = {\sum }_{i = 1}^{k} w ( {v}_{i - 1} , {v}_{i} )$$

In graph theory, a solution to a shortest path problem can attempt to find a path between two vertices in a graph such that the sum of the weights of its constituent edges are minimized. A shortest path, δ, can be defined for graphs whether undirected, directed, or mixed. In some examples, the present techniques can be implemented for directed graphs. Directed graphs can involve consecutive vertices in p to be connected by an appropriate directed edge. Let eᵢⱼ be an edge incident to both vᵢ and vⱼ in G. Given a real-valued weight function w(⋅): E→R, and an directed simple graph G, the shortest path δ from v₁ to vₙ is the path p= [symbol] v₁, v₂, . . . , vₙ [symbol] , that over all possible n minimizes the following equation:

$${δ}_{{v}_{1} {v}_{n}} = {δ}_{{v}_{1} {v}_{n}} = \{ {\sum }_{i = 1}^{n - 1} w ( {e}_{i , i + 1} ) \}$$

Where there is no path from v₁ to vₙ, then δᵥ_{₁}ᵥ_{ₙ}=∞, as follows:

$${δ}_{{v}_{1} {v}_{n}} = \{ \begin{matrix}min \{ w ( p ) : {v}_{1}^{p} {v}_{n} \} , & if {v}_{1}^{p} {v}_{n} exists \\ ∞ & otherwise\end{matrix}$$

When G is a directed graph, there can be multiple edges between a given pair of vertices, with an edge connecting distinct vertices u and v written as a pair (u, v). In directed graphs, edges convey directionality such that (u, v)≠(v, u), thus eₘ=(u, v) and eₘ₊₁=(v, u), where the edge numbering is for illustrative purposes and does not to relate to a canonical labeling of the edges.

A single-source shortest-path algorithm can be implemented. In the present techniques, the edge weight w can represent a cost associated with traversing the edge (u, v) between vertices u and v, and w(p) can be a cost associated with the path p. It can be that there are not negative costs in implementing the present techniques, and Dijkstra's algorithm can be implemented to solve for δ.

Dijkstra's algorithm can be a single-source shortest-path algorithm for graph networks with a O(|E|+|V| log |V|) upper bound (using a Fibonacci heap min-priority queue), and an assumption that w>0, ∀w∈G. Dijkstra's algorithm can satisfy the following properties:
1. Triangle Inequality
   For any edge (u, v)∈E, there is δₛᵥ≤δₛᵤ+wᵤᵥ.
2. Upper-bound Property
   d[v]≥δₛᵥ for all vertices v∈V, and once d[v] achieves the value δₛᵥ, it can be that it does not change.
3. No-path Property
   If there is no path from s to v, then d[v]=δₛᵥ=∞.
4. Convergence Property
   If su→v is the shortest path in G for some u, v∈V, and if d[u]=δₛᵤ at some time prior to relaxing edge (u, v), then d[v]=δₛᵥ afterwards.
5. Path-relaxation Property
   If p= [symbol] v₁, v₂, . . . , vₙ [symbol] , is a shortest path from s=v₀ to vₖ, and the edges of p are relaxed in the order (v₀,v₁, (v₁,v₂), . . . , (vₖ₋₁,vₖ), then d[vₖ]=δₛᵥ_{ₖ}. This property can hold regardless of other relaxation steps that occur, even where they are intermixed with relaxations of the edges of p.
6. Predecessor-subgraph Property
   Once d[v]=δₛᵥ, ∀v∈V, the predecessor subgraph can be the shortest-paths tree rooted at s.

Dijkstra's algorithm can initialize with a constraint of the triangle inequality, and then recursively relax the values to tighten the upper bound and thus, find the shortest path δ. The initialization parameters are described as follows, where π is the predecessor to v, ∀v∈V, and d[⋅] can be an attribute that represents an upper bound on the weight of δₛᵥ. The value d[⋅] can also be viewed as an estimate of the shortest path.

Initializing a single-source (G, s) can be expressed using the following pseudocode:

```
for each vertex v ∈ V [G] do
  d[v] ← ∞
  π[v] ← NIL
end for
d[s] ← 0
```

A process of relaxing an edge (u, v) can be a test of whether the shortest path to v can be improved by going through u and, if so, updating π[v] and decreasing d[v]. The relaxation process can be described as follows, where w(u, v) is an edge weight associated with edge (u, v). In some examples, relaxation can the only means by which shortest path estimates d[⋅] and predecessors π[⋅] change.

Relaxing (u, v, w) can be expressed using the following pseudocode:

```
if d[v] > d[u] + w(u, v) then
  d[v] ← d[u] + w(u, v)
  π[v] ← u
end if
```

Dijkstra's algorithm can maintain a set S of vertices whose final shortest-path weights from the source s have been determined. Dijkstra's algorithm can repeatedly select the vertex u∈(V-S) with the minimum shortest-path estimate, add u to S, and then relax all edges leaving u. In the following implementation, a min-priority queue Q of vertices can be keyed by their d values, and A can be the adjacency matrix of G. Dijkstra's algorithm can be described as greedy because it chooses the lightest (e.g., lowest weight edge) or closest vertex in V-S to add to set S.

Dijkstra's algorithm (u, v, w) can be expressed using the following pseudocode:

```
INITIALIZE-SINGLE-SOURCE(G, s)
S←Ø
Q ← V[G]
while Q ≠ Ø do
  u ← EXTRACT-MIN(Q)
  S ← S ∪ {u}
  for each vertex v ∈ A[u] do
    RELAX(u, v, w)
  end for
end while
```

EXTRACT-MIN in the above pseudocode can comprise a recursive search for the minimum node of a Fibonacci heap. A Fibonacci heap can comprise a disjoint heap-ordered collection of rooted trees. Using Fibonacci heaps for priority queues, instead of binomial heaps, can improve an asymptotic running time of algorithms when certain criteria are met. For example, Fibonacci heaps can provide improved performance over binomial heaps when the number of EXTRACT-MIN operations is small relative to the number of other operations. Dijkstra's algorithm can have many more decrease-key calls than extract-min calls, thus a Fibonacci heap approach can be implemented for EXTRACT-MIN in the above pseudocode.

As previously discussed, there can be several paths p∈G. That is, many paths can lead from an origin vertex to a target vertex in G (being a single-source shortest-path), and a minimum cost path can be identified. A minimum cost path can be a path p where the sum of the edge weights w, ∀w∈p, is minimized according to Dijkstra's algorithm, as expressed in the above pseudocode. A trivial shortest path can be defined by the fewest number of vertices visited on the path from the origin vertex to the target vertex. A minimum cost path can be different from a trivial shortest path. A weighted-edge minimum shortest path δ, as defined by Dijkstra's algorithm, can fulfilled criteria for the minimum cost path as w>0, ∀w∈G, thus δ can be the minimum cost path.

In examples of the present techniques, the graph G can be optimized using the minimum cost path δ, ∀v∈G to achieve issue resolution. The optimized graph G* can provide a revised framework for cost-optimized decision making and recommended actions using the original data from the inaccurate logging of repair actions.

Technicians can log repair actions they execute on damaged hardware at our repair depot. The event logs can be human-generated and -annotated, and they can be prone to error. Further, less expensive repair actions can be favored over more expensive actions, while minimizing a total number of repair steps required to remedy the issue, as technician repair time can also be a cost minimization concern. With these considerations in mind, a minimum cost path approach can be applied to event logs.

An event log can identify repair actions data, where in some examples, some repair sequences involve eight separate actions to achieve resolution. In some examples, repair actions that do not contribute to resolution are ignored, as are actions in which a part is replaced but later found to be fully functional (that is, a part with no fault found). Relevant repair actions can be assembled into an edge-weighted directed graph G, which in an example has 802 vertices and 26,667 edges. A directed graph can be chosen where technicians do not log data of each action in accurate succession, so the order of repair actions in an event log can be considered irrelevant. A direction of a graph can be determined by a succession of steps for a single repair, and the actions involved in achieving resolution. A mean cost of a repair action for a commodity under repair can be used as an edge weight w for each e∈G. Diagnostic actions can be included and assigned a nominal cost of w=1. Optimization of G→G*, using minimum cost path criteria, in this example, can result in an optimized graph G* with 401 vertices and 400 edges.

Analysis of event logs in G can demonstrate that favoring frequent repair actions, without a consideration for action costs, can lead to a prioritization of expensive recommended repair actions. Conversely, in an example applying a minimum cost path approach to event logs in G*resulted in favorable, expedient, and low-cost recommended actions.

An efficient approach for process mining of repair depot data sets can be implemented. Commodity repair event logs from repair depots can be analyzed to construct a graph network. The graph network can be optimized with a minimum cost path function. This approach can achieve a lowest-cost path from the issue to resolution. Repair action recommendations of the minimum cost path approach can be one or two orders of magnitude less expensive than the actions recommended by a trivial shortest path on an unoptimized graph. Further, the minimum cost path approach can provide a lower cost recommended action, with the same number of steps, versus a more expensive action recommended by the trivial shortest path approach.

### Example Architectures and Graphs

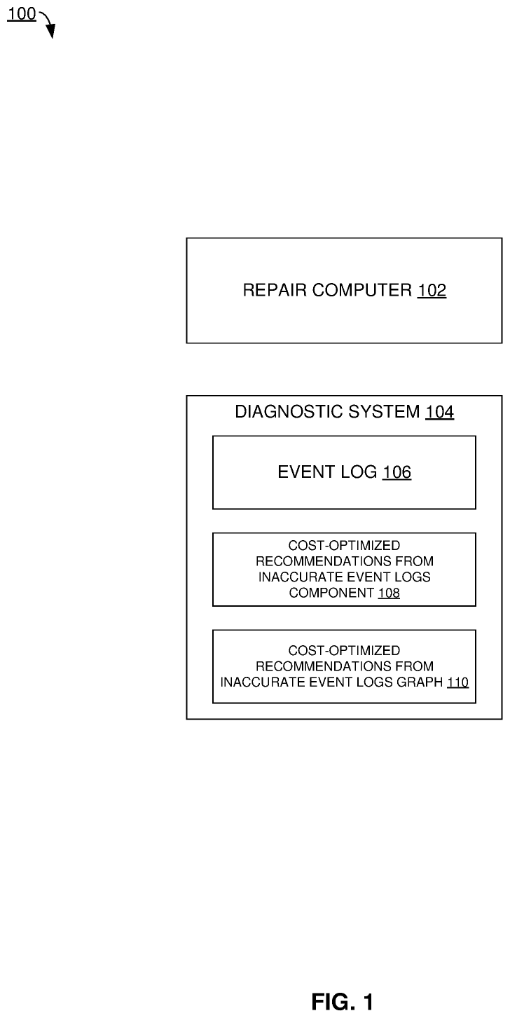

FIG. 1 illustrates an example system architecture 100 that can facilitate cost-optimized recommendations from inaccurate event logs, in accordance with an embodiment of this disclosure.

System architecture 100 comprises repair computer 102, and diagnostic system 104. In turn, diagnostic system 104 comprises event log 106, cost-optimized recommendations from inaccurate event logs component 108, and cost-optimized recommendations from inaccurate event logs graph 110.

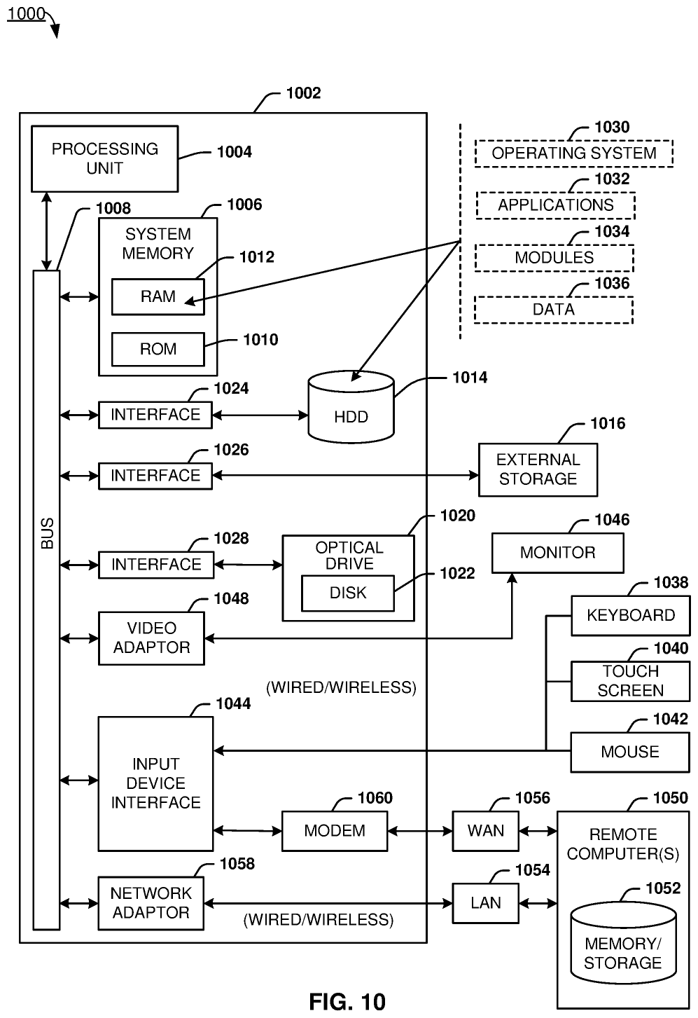

Each of repair computer 102 and diagnostic system 104 can be implemented with part(s) of computing environment 1000 of FIG. 10.

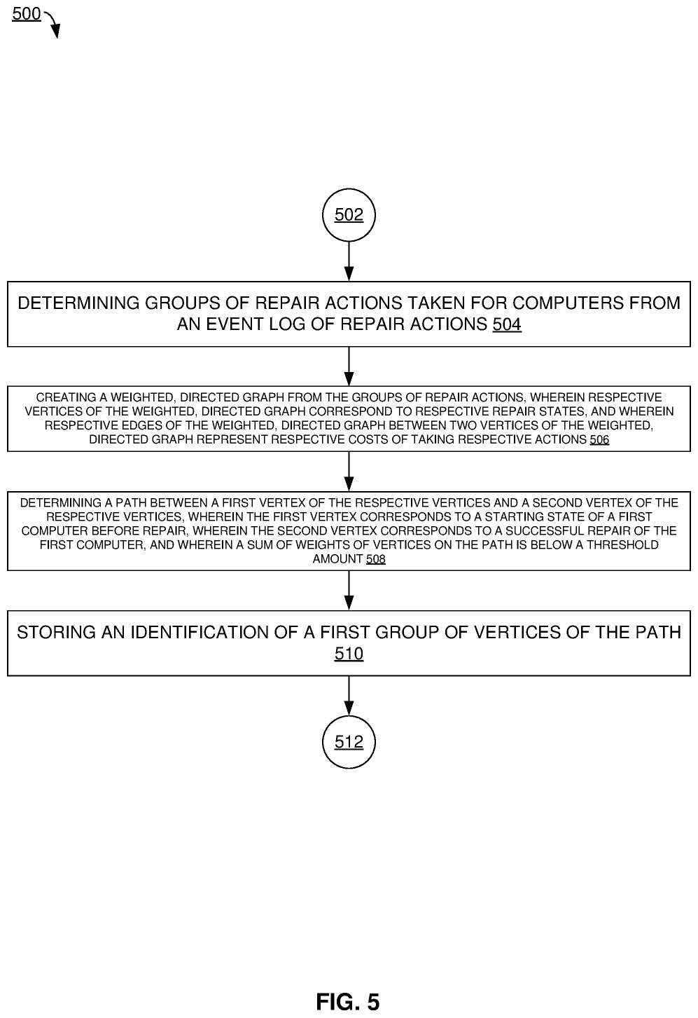

In some examples, cost-optimized recommendations from inaccurate event logs component 108 can implement part(s) of the process flows of FIGS. 5-9 to facilitate cost-optimized recommendations from inaccurate event logs.

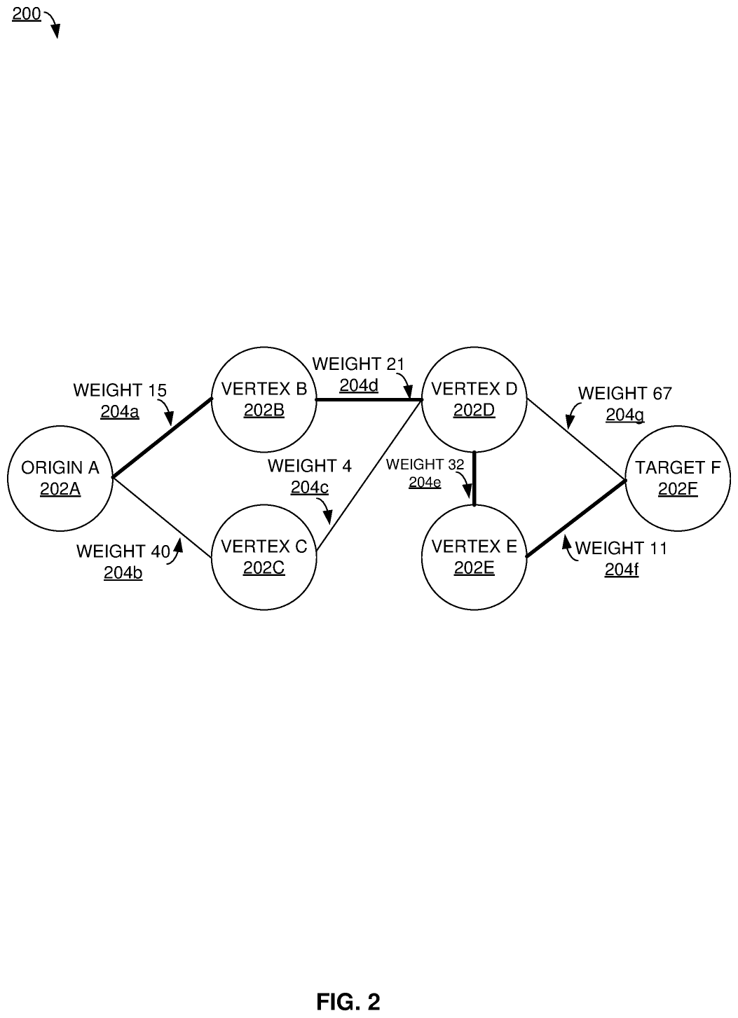

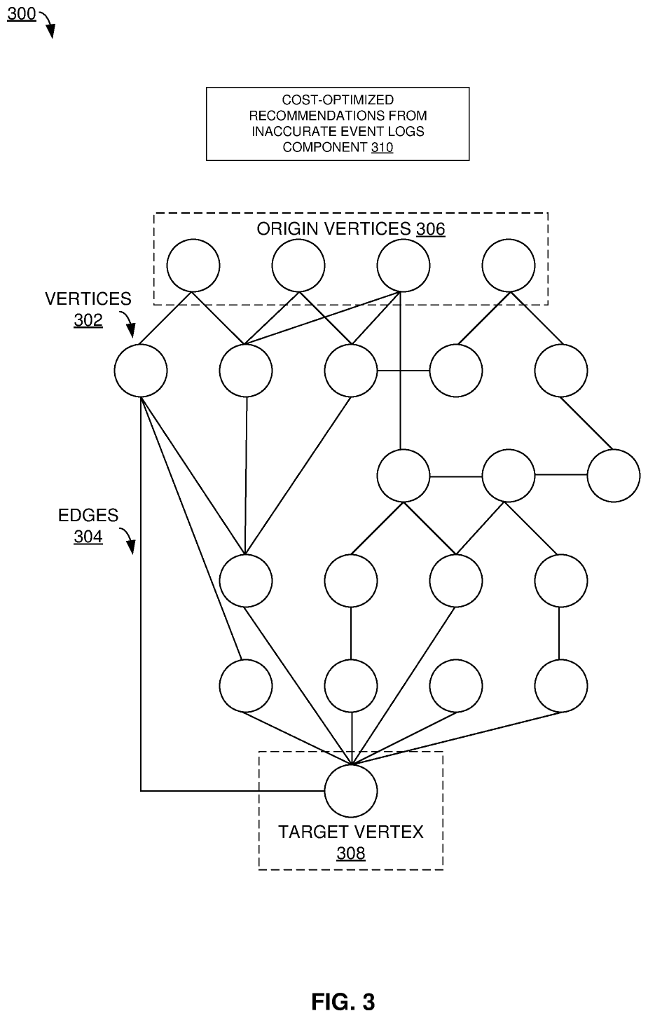

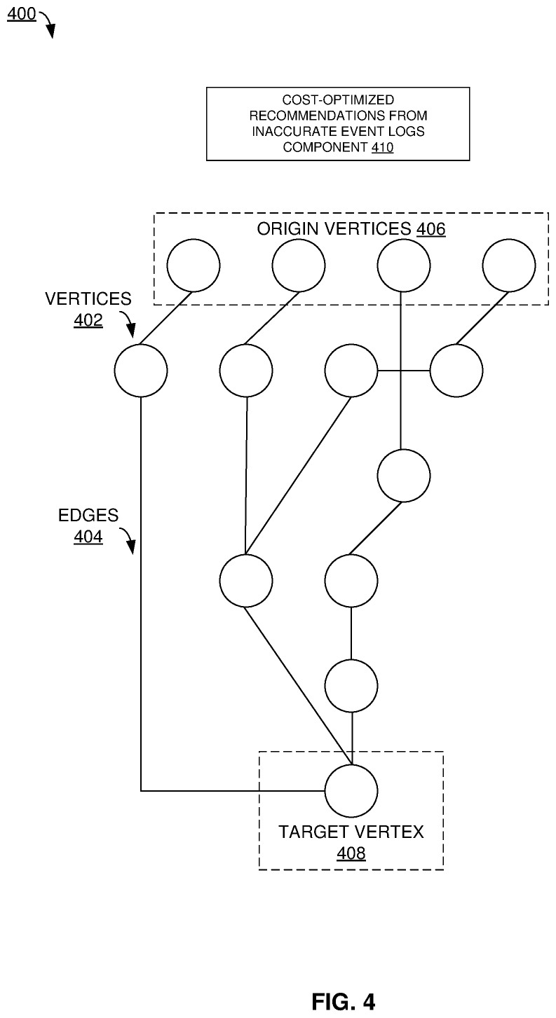

Repair computer 102 can be a computer that is malfunctioning. Diagnostic system 104 can provide a recommended set of repair actions for a technician to take in repairing repair computer 102. Event log 106 can comprise information about prior repairs of malfunctioning computers. Cost-optimized recommendations from inaccurate event logs component 108 can take the information of event log 106 to produce cost-optimized recommendations from inaccurate event logs graph 110 (which can be similar to graph 200 of FIG. 2, graph 300 of FIG. 3, and/or graph 400 of FIG. 4). Cost-optimized recommendations from inaccurate event logs component 108 can use the information in cost-optimized recommendations from inaccurate event logs graph 110 to find a minimum cost path through the graph, and recommend repair actions to take based on that minimum cost path

It can be appreciated that system architecture 100 is one example system architecture for cost-optimized recommendations from inaccurate event logs, and that there can be other system architectures that facilitate cost-optimized recommendations from inaccurate event logs.

FIG. 2 illustrates an example graph 200 with a minimum cost path, and that can facilitate cost-optimized recommendations from inaccurate event logs, in accordance with an embodiment of this disclosure. In some examples, graph 200 can be similar to cost-optimized recommendations from inaccurate event logs graph 110 of FIG. 1.

Graph 200 comprises vertices (origin A 202A, vertex B 202B, vertex C 202C, vertex D 202D, vertex E 202E, and target F 202F) and edges (edge 204A, edge 204B, edge 204C, edge 204D, edge 204E, edge 204F, and edge 204G). Origin A 202A is the vertex at which a computer begins when it needs a repair, and target 202F is the vertex that represents that computer being repaired. Each edge has a corresponding weight—edge 204A has a weight of 15, edge 204B has a weight of 40, edge 204C has a weight of 4, edge 204D has a weight of 21, edge 204E has a weight of 32, edge 204F has a weight of 11, and edge 204G has a weight of 67.

A goal of cost-optimized recommendations from inaccurate event logs component 108 of FIG. 1 is to determine a path from origin A 202A to target F 202F that has a minimum cost of the weights of the edges traversed. Cost-optimized recommendations from inaccurate event logs component 108 can determine that this path is origin A 202A, vertex B 202B, vertex D 202D, vertex E 202E, and target F 202F.

It can be noted that this minimum cost path is different from the trivial shortest path. In contrast to the minimum cost path, the trivial shortest path can be origin A 202A, vertex B 202B, vertex D 202D, and target F 202F, or origin A 202A, vertex B 202B, vertex C202C, and target F 202F. That is, for the minimum cost path, w(δ_{af})=79 from the origin vertex to the target vertex. In contrast, the trivial shortest paths do not have the minimum cost path, with w(p_{af})=103 and 111, respectively.

FIG. 3 illustrates an example graph 300 with multiple starting vertices, and that can facilitate cost-optimized recommendations from inaccurate event logs, in accordance with an embodiment of this disclosure. In some examples, graph 300 can be similar to cost-optimized recommendations from inaccurate event logs graph 110 of FIG. 1, before it is optimized.

Graph 300 comprises vertices 302, edges 304, origin vertices 306, target vertex 308, and cost-optimized recommendations from inaccurate event logs component 310 (which can be similar to cost-optimized recommendations from inaccurate event logs component 310 of FIG. 1).

Vertices 302 and edges 304 can be generated by analyzing an event log, such as event log 106 of FIG. 1. As depicted, graph 300 comprises 21 vertices and 30 edges. This number of vertices and edges can be reduced to produce an optimized version of graph 300 in graph 400 of FIG. 4.

In graph 300, there can be a condition (represented by a vertex) and an associated action (represented by an edge). A cost associated with the action can be the edge weight, and the weight can be directional. Using the format [condition->action->resolution], examples of conditions, actions, and resolutions can be [‘power battery swollen’, ‘replaced commodity battery’, ‘resolved’]; [‘power intermittent power loses power boot’, ‘reseat cables internal other cable’, ‘resolved’]; [‘bluescreen after osri on boot’. ‘replaced commodity motherboard’, ‘operating system clean install by pxenetwork’, ‘resolved’]; and [‘video internal distortion on a cold start’, ‘replaced commodity lcd and accessory’, ‘lcd bist fail fail’, ‘replaced commodity palmrest and touchpad’, ‘replaced mechanicalplastics bottom cover’, ‘resolved’]

FIG. 4 illustrates an example graph 400 that is optimized, and that can facilitate cost-optimized recommendations from inaccurate event logs, in accordance with an embodiment of this disclosure. In some examples, graph 400 can be similar to graph 300 of FIG. 3, after it is optimized.

Graph 400 comprises vertices 402 (which can be similar to vertices 302 of FIG. 3), edges 404 (which can be similar to edges 304), origin vertices 406 (which can be similar to origin vertices 306), target vertex 408 (which can be similar to target vertex 308), and cost-optimized recommendations from inaccurate event logs component 410 (which can be similar to cost-optimized recommendations from inaccurate event logs component 310).

Graph 400 can be an optimized version of graph 300. Using the terminology above, where graph 300 is graph G, graph 400 can be graph G*.

### Example Process Flows

FIG. 5 illustrates an example process flow 500 that can facilitate cost-optimized recommendations from inaccurate event logs, in accordance with an embodiment of this disclosure. In some examples, one or more embodiments of process flow 500 can be implemented by cost-optimized recommendations from inaccurate event logs component 108 of FIG. 1, or computing environment 1000 of FIG. 10.

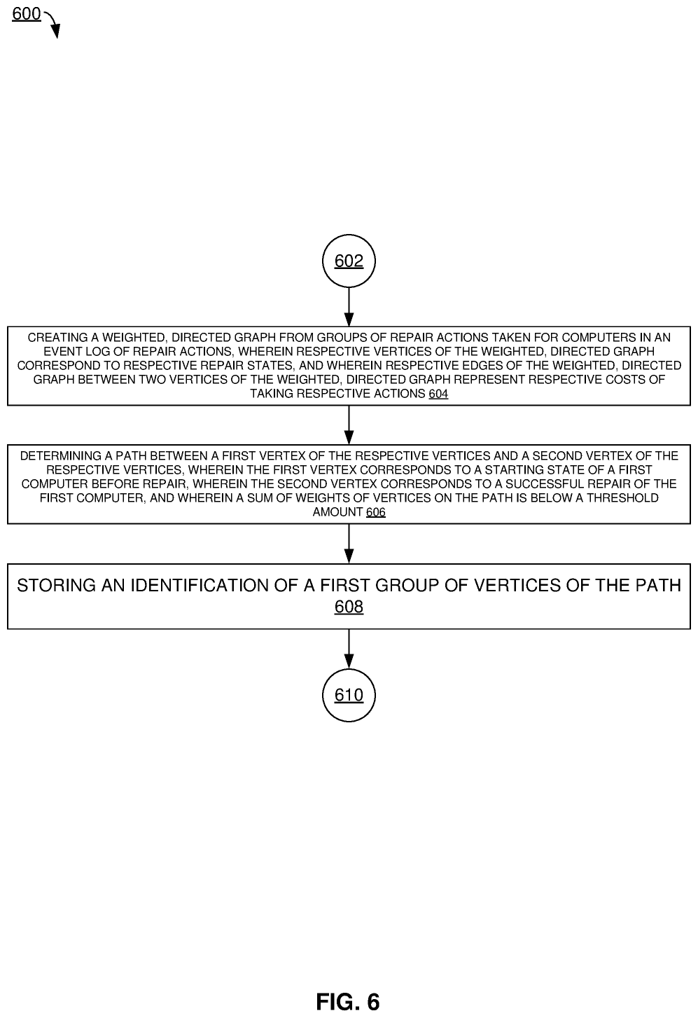

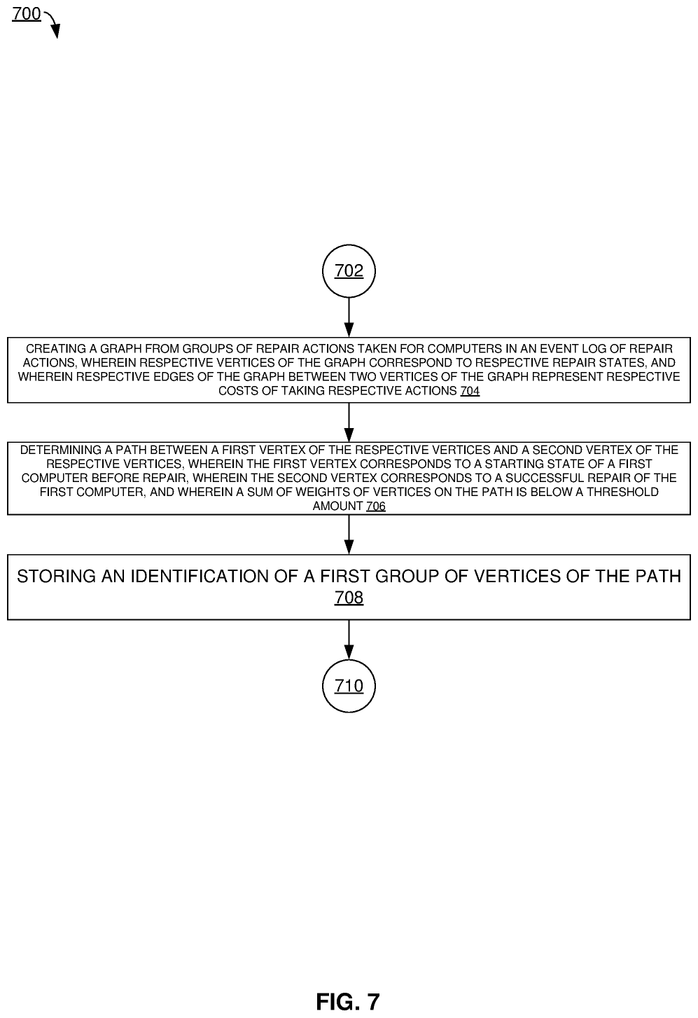

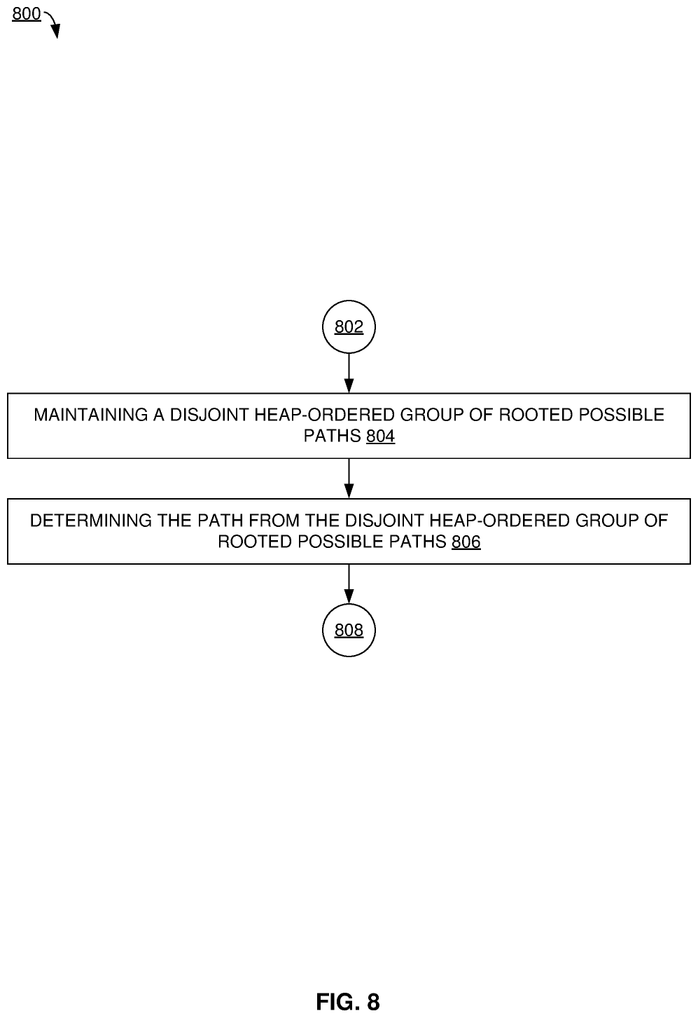

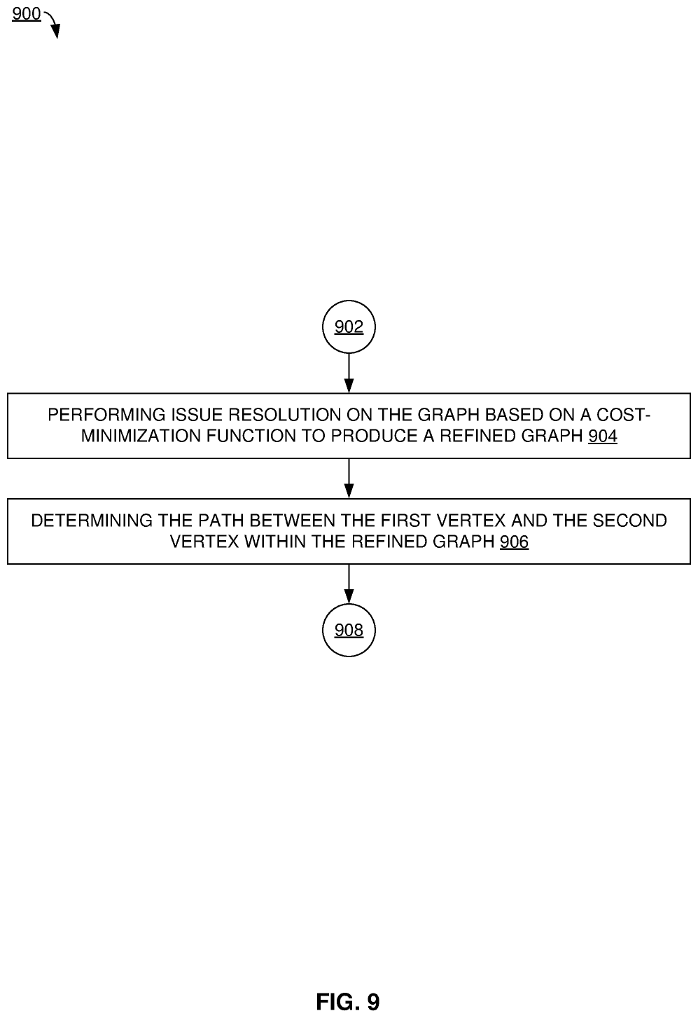

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, and/or process flow 900 of FIG. 9.

Process flow 500 begins with 502, and moves to operation 504. Operation 504 depicts determining groups of repair actions taken for computers from an event log of repair actions. This can involve parsing an event log (e.g., event log 106 of FIG. 1) to determine what repair actions have been taken.

After operation 504, process flow 500 moves to operation 506.

Operation 506 depicts creating a weighted, directed graph from the groups of repair actions, wherein respective vertices of the weighted, directed graph correspond to respective repair states, and wherein respective edges of the weighted, directed graph between two vertices of the weighted, directed graph represent respective costs of taking respective actions. That is, the parsed event log from operation 504 can be transformed into a weighted, directed graph, such as cost-optimized recommendations from inaccurate event logs graph 110 of FIG. 1.

In some examples, the event log indicates respective orders of repair actions within the groups of repair actions, and operation 506 comprises disregarding the respective orders of repair actions when creating the weighted, directed graph. That is, it can be determined that an order of repair actions taken in the event log is unreliable. For example, the order of repair actions could have been manually entered into the event log by a technician, who made errors when entering the information. To mitigate against this unreliable data in event logs, the order that repair actions were taken indicated in the event log can be disregarded when creating the graph.

In some examples, a first edge of the weighted, directed graph corresponds to a diagnostic action, and wherein a first weight of the first edge is less than weights that correspond to repair actions in the weighted, directed graph. That is, edges of the graph can represent repair actions or diagnostic actions that move the computer being repaired between states (represented by vertices of the graph). A repair action can comprise replacing a part in the computer, and can have a cost that corresponds to the cost of the new part. A diagnostic action can also be assigned a cost, and this cost for a diagnostic action can be smaller than any repair action. For example, if the lowest-cost repair action is 3 (e.g., $3), diagnostic actions can be assigned a cost of 1.

In some examples, the respective costs of taking respective actions represent mean costs of performing multiple iterations of performing the respective actions. That is, where a repair action comprises replacing a part, a cost of that part can vary over time, or by supplier. A mean cost of the replacement part can be determined, and used as the cost of a corresponding repair action.

After operation 506, process flow 500 moves to operation 508.

Operation 508 depicts creating determining a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. That is, a shortest path through the graph of operation 506 can be determined (which can be similar to as depicted in graph 200 of FIG. 2). This shortest path can correspond to an order of repair actions to take for a computer, such as for repair computer 102 of FIG. 1.

In some examples, the threshold amount can be a shortest path. In other examples, the threshold amount can comprise the largest sum of weights among the n shortest paths, or a percentage amount relative to the shortest path, such as 110% of the weights of the shortest path.

In some examples, the path between the first vertex and the second vertex is a lowest-cost path among a group of paths between the first vertex and the second vertex. The lowest-cost path can comprise a path that has the smallest sums of weights of its edges among candidate paths that lead to a successful repair of the computer being repaired.

In some examples, the first vertex belongs to a second group of vertices of the weighted, directed graph, and wherein respective vertices of the second group of vertices represent respective starting states. That is, the graph can have multiple starting states that correspond to multiple types of malfunctioning that computers in need of repair are experiencing. This can be similar to the multiple starting states of graph 300 of FIG. 3.

After operation 508, process flow 500 moves to operation 510.

Operation 510 depicts creating storing an identification of a first group of vertices of the path. That is, the shortest path (and its vertices) can be stored in a computer memory, such as a computer memory of diagnostic system 104 of FIG. 1.

After operation 510, process flow 500 moves to 512, where process flow 500 ends.

FIG. 6 illustrates another example process flow 600 that can facilitate cost-optimized recommendations from inaccurate event logs, in accordance with an embodiment of this disclosure. In some examples, one or more embodiments of process flow 600 can be implemented by cost-optimized recommendations from inaccurate event logs component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, process flow 800 of FIG. 8, and/or process flow 900 of FIG. 9.

Process flow 600 begins with 602, and moves to operation 604. Operation 604 depicts creating a weighted, directed graph from groups of repair actions taken for computers in an event log of repair actions, wherein respective vertices of the weighted, directed graph correspond to respective repair states, and wherein respective edges of the weighted, directed graph between two vertices of the weighted, directed graph represent respective costs of taking respective actions. In some examples, operation 604 can be implemented in a similar manner as operations 504-506 of FIG. 5.

In some examples, the event log comprises a table, wherein respective rows of the table represent respective events, and wherein the respective events comprise respective activity names, respective case identifiers, and respective timestamps.

After operation 604, process flow 600 moves to operation 606.

Operation 606 depicts determining a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. In some examples, operation 606 can be implemented in a similar manner as operation 508 of FIG. 5.

After operation 606, process flow 600 moves to operation 608.

Operation 608 depicts storing an identification of a first group of vertices of the path. In some examples, operation 608 can be implemented in a similar manner as operation 510 of FIG. 5.

After operation 608, process flow 600 moves to 610, where process flow 600 ends.

FIG. 7 illustrates another example process flow 700 that can facilitate cost-optimized recommendations from inaccurate event logs, in accordance with an embodiment of this disclosure. In some examples, one or more embodiments of process flow 700 can be implemented by cost-optimized recommendations from inaccurate event logs component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, and/or process flow 900 of FIG. 9.

Process flow 700 begins with 702, and moves to operation 704. Operation 704 depicts creating a graph from groups of repair actions taken for computers in an event log of repair actions, wherein respective vertices of the graph correspond to respective repair states, and wherein respective edges of the graph between two vertices of the graph represent respective costs of taking respective actions. In some examples, operation 704 can be implemented in a similar manner as operations 604-606 of FIG. 6.

In some examples, the event log indicates respective orders of repair actions within the groups of repair actions, and operation 704 comprises disregarding the respective orders of repair actions when creating the graph. That is, an order of actions identified in an event log can be considered to be unreliable, so the actions can be used in creating the graph, but an order of those actions in the event log can be ignored in creating the graph.

After operation 704, process flow 700 moves to operation 706.

Operation 706 depicts determining a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount. In some examples, operation 706 can be implemented in a similar manner as operation 608 of FIG. 6.

In some examples, operation 706 comprises performing issue resolution on the graph based on a cost-minimization function to produce a refined graph, and determining the path between the first vertex and the second vertex within the refined graph. In some examples, producing the refined graph comprises removing, from the graph, an unused vertex that is omitted from minimum cost paths between a second group of vertices that comprises the first vertex and a third group of vertices that comprises the second vertex, and removing, from the graph, an unused edge that is omitted from the minimum cost paths. This can be implemented in a similar manner as process flow 800 of FIG. 8.

In some examples, a first edge of the graph corresponds to a diagnostic action, and wherein a first weight of the first edge is less than weights that correspond to repair actions in the graph. That is, repair actions (which can involve replacing a part) and diagnostic actions (which can involve learning more about a problem with the computer) can be made, and diagnostic actions can be assigned weights that are lower than all repair actions.

After operation 706, process flow 700 moves to operation 708.

Operation 708 depicts storing an identification of a first group of vertices of the path. In some examples, operation 708 can be implemented in a similar manner as operation 610 of FIG. 6.

After operation 708, process flow 700 moves to 710, where process flow 700 ends.

FIG. 8 illustrates an example process flow 800 for optimizing a graph using a cost-minimization function to achieve issue resolution, and that can facilitate cost-optimized recommendations from inaccurate event logs, in accordance with an embodiment of this disclosure. In some examples, one or more embodiments of process flow 800 can be implemented by cost-optimized recommendations from inaccurate event logs component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, and/or process flow 900 of FIG. 9.

Process flow 800 begins with 802, and moves to operation 804. Operation 804 depicts performing issue resolution on the weighted, directed graph based on a cost-minimization function to produce a refined graph.

In some examples, operation 804 comprises removing, from the weighted, directed graph, an unused vertex that is omitted from minimum cost paths between a second group of vertices that comprises the first vertex and a third group of vertices that comprises the second vertex. That is, a graph can be pruned to remove vertices that are not used in any lowest-cost path for repairing a computer.

In some examples, operation 804 comprises removing, from the weighted, directed graph, an unused edge that is not contained in a minimum cost path between a second group of vertices that comprises the first vertex and a third group of vertices that comprises the second vertex. That is, a graph can be pruned to remove edges that are not used in any lowest-cost path for repairing a computer.

In some examples, the weighted, directed graph has a first number of vertices, wherein the refined graph has a second number of vertices, and wherein the first number of vertices is greater than the second number of vertices. That is, the graph can be refined to make it smaller in terms of a number of vertices.

In some examples, the weighted, directed graph has a first number of edges, wherein the refined graph has a second number of edges, and wherein the first number of edges is greater than the second number of edges. That is, the graph can be refined to make it smaller in terms of a number of edges.

After operation 804, process flow 800 moves to operation 806.

Operation 806 depicts determining the path between the first vertex and the second vertex within the refined graph. That is, the refined graph can be used for determining a minimum-cost path, and a corresponding set of repair actions to take.

After operation 806, process flow 800 moves to 808, where process flow 800 ends.

FIG. 9 illustrates an example process flow 900 for using a Fibonacci heap to facilitate cost-optimized recommendations from inaccurate event logs, in accordance with an embodiment of this disclosure. In some examples, one or more embodiments of process flow 900 can be implemented by cost-optimized recommendations from inaccurate event logs component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, and/or process flow 800 of FIG. 8.

Process flow 900 begins with 902, and moves to operation 904. Operation 904 depicts maintaining a disjoint heap-ordered group of rooted possible paths.

After operation 904, process flow 900 moves to operation 906.

Operation 906 depicts determining the path from the disjoint heap-ordered group of rooted possible paths.

After operation 906, process flow 900 moves to 908, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of repair computer 102 or diagnostic system 104 of FIG. 1.

In some examples, computing environment 1000 can implement one or more embodiments of the process flows of FIGS. 5-9 to facilitate cost-optimized recommendations from inaccurate event logs.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
determining groups of repair actions taken for computers from an event log of repair actions;
creating a weighted, directed graph from the groups of repair actions, wherein respective vertices of the weighted, directed graph correspond to respective repair states, and wherein respective edges of the weighted, directed graph between two vertices of the weighted, directed graph represent respective costs of taking respective actions;
determining a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount; and
storing an identification of a first group of vertices of the path.

2. The system of claim 1, wherein the event log indicates respective orders of repair actions within the groups of repair actions, and wherein creating the weighted, directed graph comprises:
disregarding the respective orders of repair actions when creating the weighted, directed graph.

3. The system of claim 1, wherein the path between the first vertex and the second vertex is a lowest-cost path among a group of paths between the first vertex and the second vertex.

4. The system of claim 1, wherein the first vertex belongs to a second group of vertices of the weighted, directed graph, and wherein respective vertices of the second group of vertices represent respective starting states.

5. The system of claim 1, wherein the operations further comprise:
performing issue resolution on the weighted, directed graph based on a cost-minimization function to produce a refined graph; and
determining the path between the first vertex and the second vertex within the refined graph.

6. The system of claim 1, wherein a first edge of the weighted, directed graph corresponds to a diagnostic action, and wherein a first weight of the first edge is less than weights that correspond to repair actions in the weighted, directed graph.

7. The system of claim 1, wherein the respective costs of taking respective actions represent mean costs of performing multiple iterations of performing the respective actions.

8. A method, comprising:
creating, by a system comprising a processor, a weighted, directed graph from groups of repair actions taken for computers in an event log of repair actions, wherein respective vertices of the weighted, directed graph correspond to respective repair states, and wherein respective edges of the weighted, directed graph between two vertices of the weighted, directed graph represent respective costs of taking respective actions;
determining, by the system, a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount; and
storing, by the system, an identification of a first group of vertices of the path.

9. The method of claim 10, further comprising:
performing, by the system, issue resolution on the weighted, directed graph based on a cost-minimization function to produce a refined graph; and
determining, by the system, the path between the first vertex and the second vertex within the refined graph.

10. The method of claim 9, wherein producing the refined graph comprises:
removing, by the system and from the weighted, directed graph, an unused vertex that is omitted from minimum cost paths between a second group of vertices that comprises the first vertex and a third group of vertices that comprises the second vertex.

11. The method of claim 9, wherein producing the refined graph comprises:
removing, by the system and from the weighted, directed graph, an unused edge that is not contained in a minimum cost path between a second group of vertices that comprises the first vertex and a third group of vertices that comprises the second vertex.

12. The method of claim 9, wherein the weighted, directed graph has a first number of vertices, wherein the refined graph has a second number of vertices, and wherein the first number of vertices is greater than the second number of vertices.

13. The method of claim 9, wherein the weighted, directed graph has a first number of edges, wherein the refined graph has a second number of edges, and wherein the first number of edges is greater than the second number of edges.

14. The method of claim 8, wherein the event log comprises a table, wherein respective rows of the table represent respective events, and wherein the respective events comprise respective activity names, respective case identifiers, and respective timestamps.

15. A non-transitory computer-readable medium comprising instructions that, in response to execution, cause a system comprising a processor to perform operations, comprising:
creating a graph from groups of repair actions taken for computers in an event log of repair actions, wherein respective vertices of the graph correspond to respective repair states, and wherein respective edges of the graph between two vertices of the graph represent respective costs of taking respective actions;
determining a path between a first vertex of the respective vertices and a second vertex of the respective vertices, wherein the first vertex corresponds to a starting state of a first computer before repair, wherein the second vertex corresponds to a successful repair of the first computer, and wherein a sum of weights of vertices on the path is below a threshold amount; and
storing an identification of a first group of vertices of the path.

16. The non-transitory computer-readable medium of claim 15, wherein determining the path between the first vertex and the second vertex comprises:
maintaining a disjoint heap-ordered group of rooted possible paths; and
determining the path from the disjoint heap-ordered group of rooted possible paths.

17. The non-transitory computer-readable medium of claim 15, wherein the event log indicates respective orders of repair actions within the groups of repair actions, and wherein creating the graph comprises:
disregarding the respective orders of repair actions when creating the graph.

18. The non-transitory computer-readable medium of claim 15, wherein a first edge of the graph corresponds to a diagnostic action, and wherein a first weight of the first edge is less than weights that correspond to repair actions in the graph.

19. The non-transitory computer-readable medium of claim 15, wherein the operations further comprise:
performing issue resolution on the graph based on a cost-minimization function to produce a refined graph; and
determining the path between the first vertex and the second vertex within the refined graph.

20. The non-transitory computer-readable medium of claim 19, wherein producing the refined graph comprises:
removing, from the graph, an unused vertex that is omitted from minimum cost paths between a second group of vertices that comprises the first vertex and a third group of vertices that comprises the second vertex; and
removing, from the graph, an unused edge that is omitted from the minimum cost paths.
